(19) United States
(12) Patent Application Publication
(10) Pub. No.: US 2003/0137490 A1
(43) Pub. Date: Jul. 24, 2003

(54) Computer mouse

(76) Inventor: Cruise Lee, Shindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/052,336

(22) Filed: Jan. 23, 2002

(51) Int. Cl. G09G 5/08

(52) U.S. Cl. 345/163

(57) ABSTRACT

The ergonomically designed computer mouse provided by the invention comprises essentially an active key button, a passive key button, and a three shaft type scroll wheel which is able to rotate in right or reversed direction by pressing the passive key button. The low production cost mouse constructed by several conventional component parts is applicable for both radio and wired signals transmission.

### BACKGROUND OF THE INVENTION

1. Field of the Invention

The present invention relates to a computer mouse, and more precisely, to a computer mouse with an improved ergonomical structure in which a three shaft scroll wheel is operable by pressing a passive key button to rotate in right or reversed direction.

2. Description of the Prior Art

In a conventional two or three key button mouse, the user has to change pressing the key buttons in order to vary functions of the computer. Now for the convenience of glancing over the information pictures provided by the internet on a computer, there has been developed a mouse equipped with a scroll wheel to serve as an interface between the user and the computer, and the conventional two or three key button mouse has been weeded out of the markets. However, this scroll wheel equipped mouse with its scroll wheel installed admist of the two key buttons still has a disadvantage that it is restricted to be collaborately used together with the two key buttons, should a further function for the mouse be desired, an additional key button is required to be installed somewhere on the structure of the mouse. Besides, the mouse constructed as such can not release the user from troublesome constant touch on the key buttons in order to move the scroll wheel when glancing over the rapid varying pictures coming from the internet to the computer.

In view of the foregoing situation, the inventor of the present invention herein conducted intensive research based on many years of experience gained through professional engagement in the manufacturing of related products, with continuous experimentation and improvement culminating in the development of the improved structure of a scroll equipped mouse of the present invention.

### SUMMARY OF THE INVENTION

It is an object of the preset invention to provide a computer mouse equipped with a scroll wheel capable of rotating in right and reversed direction by pressing a passive key button.

It is another object of the present invention to provide a computer mouse which can prescribe the mouse function by collaborated operation of an active and a passive key buttons so as to release the user from constantly pressing the key buttons with his/her fingers for varying and searching for the pictures thus achieving an ergonomical effect.

It is one more object of the present invention to provide a computer mouse whose entire structure is enclosed with an ingeniously designed transparent cover so as to maintain a harmonic appearance for the whole structure.

It is still an object of the present invention to provide a computer mouse which is applicable for transmitting wireless or radio signals.

For achieving above mentioned objects, the ergonomically designed computer mouse provided by the present invention by the present invention comprises essentially an active key button, a passive key button, and a three shaft type scroll wheel which is able to rotate in right or reversed direction by pressing the passive key button. The mouse constructed as such is applicable for wireless or radio signals transmission.

### BRIEF DESCRIPTION OF THE DRAWINGS

For fuller understanding of the nature and objects of the invention, reference should be made to the following detailed description taken in conjunction with the accompanying drawings in which:

FIG. 1 is a three dimensional view of the mouse of the present invention;

FIGS. 2 and 3 are three dimensional exploded views of the mouse of the present invention;

FIG. 4 is an illustrative drawing showing motion of the scroll wheel of the mouse according to the present invention; and

FIG. 5 is a perspective view of the mouse in another embodiment of the present invention.

### DETAILED DESCRIPTION OF THE PREFERRED EMBODIMENT

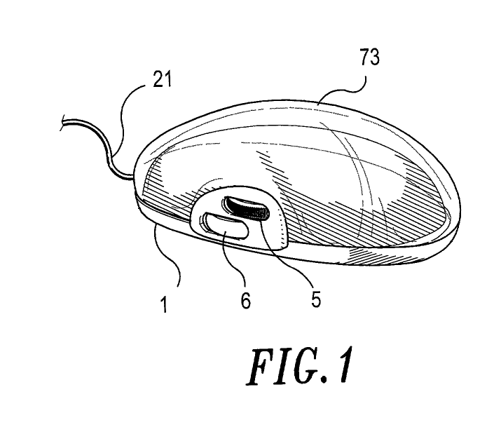

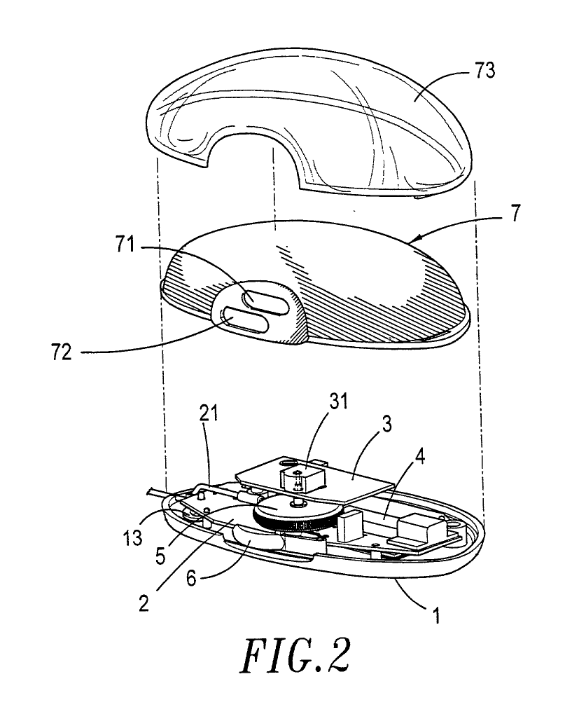

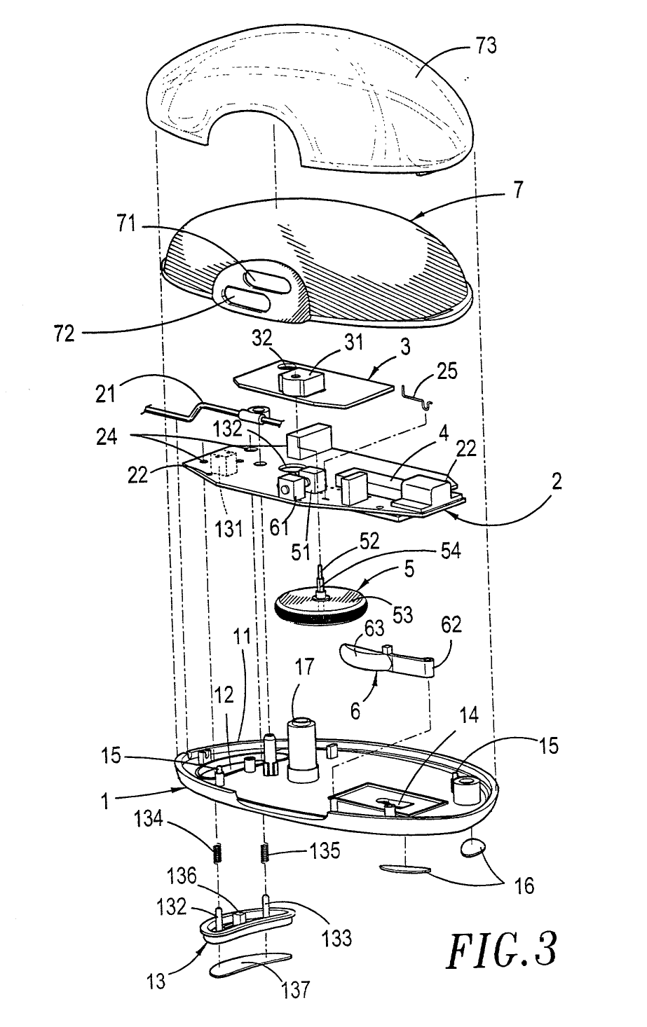

Referring to FIG. 1 through FIG. 3, the mouse of the present invention essentially comprises a base plate 1, a first circuit board 2, a second circuit board 3, a photo sensor 4, a press type scroll wheel 5, an active key button 6 and an upper cover 7. An aperture 12 is formed at the front portion 11 of the base plate 1 and a passive key button 13 is fitted in the aperture 12. A pellucid aperture 14 and a plurality of stub stoppers 15 and 17 are provided appropriately on the base plate 1. A knocker block 136 is installed on the upper part of the passive key button 13. A signal transmission conductor 21, a microswitch for the passive key button 131, a microswitch for the active key button 61, a side pressure microswitch 51 and a plurality of containment holes 22 and 24 are respectively disposed appropriately on the first circuit board 2. the containment holes 22 are aligned to the stub stoppers 15 provided on the base plate 1 so as to secure tightly the first circuit board 2 on the base plate 1 when stub stopper 15 are fitted into the containment holes 22. Meanwhile, there are two guide studs 132 and 133 extended from the passive key button 13 towards one side of the first circuit board 2, both guide studs 132 and 133 are wound respectively by compressed springs 134 and 135 so as to keep a proper distance between the knocker block 136 and the microswitch 131 by elastic force of the springs 134 and 135. The two guide studs 132 and 133 may be fitted into the containment holes 24 so as to serve as a guide and to cause the passive key button 13 to make a minor incremental displacement so that the knocker block 136 may tap the microswitch 131. The second circuit board 3 situated above the first circuit board 2 has a rotating encoder 31 and a containment hole 32 which for securing the second circuit board 3 at a distant from the first circuit board 2. The photo sensor 4 equipped on the first circuit board 2 is for detecting underside condition of the base plate 1 through the pellucid aperture formed on the first circuit board 2 so as to produce a coordinate difference signal. The press type scroll wheel 5 is constructed by a flexible axle 52 and a rotating wheel 53 pivotted thereof, one end of the axle 52 is formed into a hexagonal structure 54 capable of poking into the rotating encoder 31.

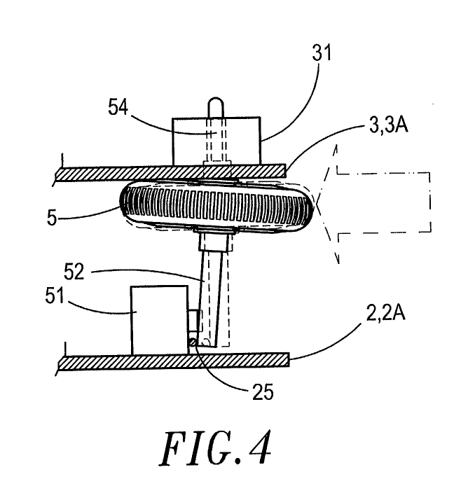

Referring to FIG. 4, a control signal is produced when tapping the microswitch 51 to actuate the encoder 31 with the flexed axle 52 by pressing and controlling the rotational direction of the scroll wheel 5. An elastic actuation rod 25 is provided for the first circuit board 2 with its one end 23 fixed to the first circuit board 2, and the other end fixed to the unstressed end of the axle 52 of the scroll wheel 5. With the aid of this elastic actuation rod 25, the axle 52 is sure to restore its initial state when the force exerted on the scroll wheel 5 is released. The active key button 6 is formed into a long stick shape with its one terminal 62 hinged to the base plate 1, while its tip 63 is able to tap and actuate the microswitch 61 for the active key button 6 side so as to produce a control signal when an extraneous force is exerted on. Two holes 71 and 72 are formed at one side of the upper cover 7 for exposing the scroll wheel 5 and the active key button 6 respectively, and the upper portion of the upper cover 7 which encloses the base plate 1 is further covered with a transparent lid 73. By so when the upper cover 7 is pressed by an extraneous force, the micorswitch 131 for the passive key button 13 side is tapped by the knocking block 136 so as to produce a control signal. With the aforesaid structure, the signals produced by the microswitches 131 and 61, and the side pressure microswitch 51, and the positional signal about the underside condition of the base plate 1 detected by the photo sensor 4 through the pellucid aperture 23 formed on the first circuit board 2 are all transmitted by the signal transmission conductor 21 disposed on the first circuit board 2 thereof as output or input signals according to the stable sliding motion of the mouse of the present invention on the flat and smooth surface with the aid of flat and slippery pads 16 and 137 adhered to the bottom surfaces of the base plate 1 and the passive key button 13 respectively.

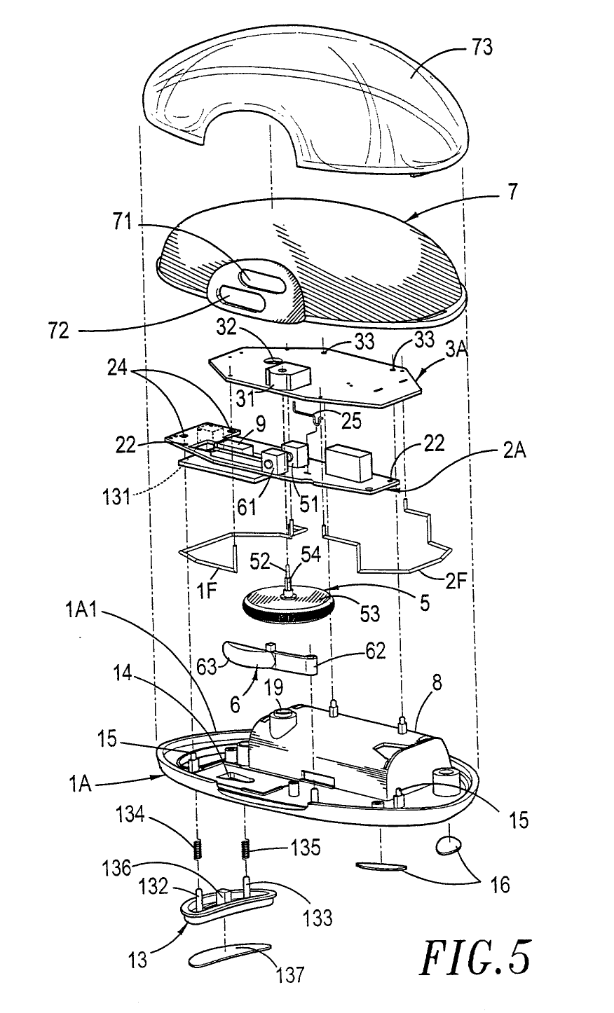

Referring to FIG. 5, the drawing shows a perspective view of the mouse in another embodiment of the present invention, wherein the previously described structure is partially modified so as to form a mouse operatable for transmitting and receiving radio signal.

The mouse in this embodiment comprises a base plate 1A, a first circuit board 2A, a second circuit board 3A, two frameworks 1F and 2F, a photo sensor 4, a press type scroll wheel 5, an active key button 6, an upper cover 7 and a power source 8. An aperture 12 is formed at the front portion 1A1 of the base plate 1A, and a passive key button 13 is fitted in the aperture 12. A pellucid aperture 14 and a plurality of stub stoppers 15, 18, 19 are provided appropriately on the base plate 1A. A microswitch 131 for the passive key button 13, a microswitch 61 for the active key button 6, a side press microswitch 51, and a plurality of containment holes 22 and 24 which are for positioning the stub stoppers 15 provided on the base plate 1 are disposed appropriately on the first circuit board 2A which is secured to the base plate 1A by inlaying stub stoppers 15 in the containment holes 22. Besides, there are two guide studs 132 and 133 extended from the passive key button 13 towards one side of the first circuit board 2A, both guide studs 132 and 133 are wound respectively by compressed springs 134 and 135 so as to keep a proper distance between a knocker block 136 of the passive key button 13 and the microswitch 131 by elastic force of the springs 34 and 135. The two guide studs 132 and 133 may be fitted into the containment holes 24 so as to serve as a guide and to cause the passive key button 13 to make minor incremental displacement so that the knocker block 136 may tap the microswithch 131. Besides, a radio device 9 is provided on the first circuit board 2A for transmitting and receiving radio signals. The power source 8 is installed on the base plate 1A for supplying the electric power required by the radio device 9. The second circuit board 3A disposed above the first circuit board 2A has a rotating encoder 31 and a plurality of containment holes 32 and 33 for securing the second circuit board 3A. The two frameworks 1F and 2F are installed on the base plate 1A for fixing the second circuit board 3A at a position above the first circuit board 2A with a certain distance. The photo sensor 4 equipped on the first circuit board 2 is for detecting outside condition of the base plate 1A through the pellucid aperture 14 formed on the first circuit board 2A so as to produce a coordinate difference signal. The press type scroll wheel 5 is constructed by a flexible axle 52 and a rotating wheel 53 pivotted thereof, one end of the axle 52 is formed into a hexagonal structure 54 capable of inserting into the rotating encoder 31.

Referring again to FIG. 4, a control signal is produced by touching the microswitch 51 to actuate the encoder 31 with the flexed axle 52 by pressing and controlling the rotational direction of the scroll wheel 5. An elastic actuation rod 25 is provided for the first circuit board 2 with its one end 23 fixed to the first circuit board 2, and the other end fixed to the unstressed end of the axle 52 of the scroll wheel 5. With the aid of this elastic actuation rod 25, the axle 52 is sure to restore its initial state when the force exerted on the scroll wheel 5 is released. The active key button 6 is formed into a long stick shape with its one terminal 62 hinged onto the base plate 1, while its tip 63 is able to touch and actuate the microswitch 61 at the active key button 6 side so as to produce a control signal when an extraneous force is exerted on. Two holes 71 and 72 are formed at one side of the upper cover 7 for exposing the scroll wheel 5 and the active key button 6 respectively, and the upper portion of the upper cover 7 which encloses the base plate 1 is further covered with a transparent lid 73. By applying a pressing force on the upper cover 7 so as to bring the passive key button 13 in touch with the microswitch 131, a control signal can be produced therefrom, with the aforesaid structure, the signals produced by the microswitches 131 and 61, and the side pressure microswitch 51, and the positional signal about the outside condition of the base plate 1 detected by the photo sensor 4 through the pellucid aperture 23 formed on the first circuit board 2A are all received and transmitted by the radio device 9 installed on the first circuit board 2A as output or input signals according to the stable sliding motion of the mouse of the present invention on a flat and smooth surface with the aid of flat and slippery pads 16 and 137 adhered to the bottom surfaces of the base plate 1 and the passive key button 13 respectively.

It emerges from the description of the above embodiments that the invention has several noteworthy advantages, in particular:

(1)The ingeniously designed passive key button facilitate the operation of the mouse more comfortable than any conventional one.

(2)Multi-functional signal transmission can be attained by lightly tapping the functional keys.

(3)The mouse of the present invention is constructed by several convertional component parts so that the production cost is low which improves the marketability of the product.

(4)The mouse of the present invention is applicable for both radio and wired signals transmission.

Although the preferred embodiments of the present invention have been elucidated for illustrative purposes, those skilled in the art will appreciate that various modifications, additions and substitutions are possible without departing from the scope or the spirit of the invention as disclosed in the accompanying claims.

What is claimed is:

1. a computer mouse comprising:
a base plate having an aperture formed at the front portion thereof, and a passive key button being fitted in said aperture, a pellucid aperture and a plurality of stub stoppers being provide appropriately on said base plate, and a knocker block being installed on the upper part of said passive key button;
a first circuit board having a signal transmission conductor, a microswitch for said passive key button, a microswitch for an active key button, a side pressure microswitch, and a plurality of containment holes all being respectively disposed appropriately on said first circuit board, said containment holes being aligned to said stub stoppers provided on said base plate so as to secure tightly said first circuit board on said base plate by fitting said stub stoppers into said containment holes;
a second circuit bard situated above said first circuit board having a rotating encoder and a containment hole for securing said second circuit board at a distant from said first circuit board;
a photo sensor equipped on said first circuit board for detecting underside condition of said base plate through said pellucid aperture formed on said first circuit board so as to produce a coordinate difference signal;
a press type scroll wheel constructed of a flexible axle pivoting a rotating wheel, and one end of said axle being formed into a hexagonal structure capable of poking into said rotating encoder, a control signal being produced when tapping said side pressure microswitch to actuate said encoder with said flexed axle by pressing and controlling the rotational direction of said scroll wheel;
an active key button formed into a long stick shape with its one terminal hinged to said base plate, while its tip being able to tap and actuate said microswitch for said active key button so as to produce a control signal when an extraneous force being exerted on; and
an upper cover having two holes formed at one side thereof for exposing said scroll wheel and said active key button respectively, said upper cover being enclosing said base plate and further having a transparent lid;
with this structure, the signals produced by aforementioned three microswitches, and the positional signal about the underside conditon of said base plate detected by said photo sensor through said pellucid aperture formed on said first circuit board are all transmitted by a signal transmission conductor disposed on said first circuit board thereof as output or input signals.

2. The mouse of claim 1, wherein two guide studs are extended from said passive key button towards one side of said first circuit board, each of both guide studs is wound respectively by a compressed spring, both guide studs are able to be fitted into the containment holes of said first circuit board so as to serve as a guide and to cause said passive key button to make a minor incremental displacement thereby being able to tap said micvoswitch for said passive key button side.

3. The mouse of claim 1, wherein an elastic actuation rod is provided for said first circuit board with its one end fixed to said first circuit board, and the other end fixed to the unstressed end of the axle of said scroll wheel, with the aid of said elastic actuation rod, said axle is able to restore its initial state when the force is released from said scroll wheel.

4. A computer mouse comprising:
a base plate having an aperture formed at the front portion thereof, and a passive key button being fitted in said aperture, a pellucid aperture and a plurality of stub stoppers being provided appropriately on said base plate, and a knocker block being installed on the upper part of said passive key button;
a first circuit board having a micro switch for said passive key button, a micorswitch for an active key button, a said pressure microswitch, and a plurality of containment holes all being respectively disposed appropriately on said first circuit board, side containment holes being aligned to said stub stoppers provided on said base plate so as to secure tightly said first circuit board on said base plate by fitting said stub stoppers into said containment holes, besides, a radio device being installed on said first circuit board for receiving and transmitting radio signals;
a second circuit board situated above said first circuit board having a rotating encoder thereon;
two frameworks instralled on said base plate for fixing said second circuit board at a position above said first circuit board with a certain distance;
a power source equipped on said base plate for supplying electricity required for driving said radio device;
a photo sensor equipped on said first circuit board for detecting underside condition of said base plate through said pellucid aperture formed on said first circuit board so as to produce a coordinate difference signal;
a press type scroll wheel constructed of a flexible axle pivoting a rotating wheel, and one end of said axle being formed into a hexagonal structure capable of poking into said rotating encoder, a control signal being produced when tapping said side pressure microswich to actuate said encoder with said flexed axle by pressing and controlling the rotational direction of said scroll wheel;
an active key button formed into a long stick shape with its one terminal hinged to said base plate, while its tip being able to tap and actuate said microswitch for said active key button so as to produce a control signal when an extraneous force being exerted on; and
an upper cover having two holes formed at one side thereof for exposing said scroll wheel and said active key button respectively, said upper cover being enclosing said base plate and further having a transparent lid, by applying a pressing force on said upper cover so as to bring said passive key button in touch with its microswitch, a control signal being produced;
with this structure, the singals produced by aforementioned three microswitches, and the positional signal about the underside condition of said base plate detected by said photo sensor through said pellucid aperture formed on said first circuit board are all received and transmitted by said radio device equipped on said first circuit board thereof as output or input signals.

5. The mouse of claim 4 wherein two guide studs are extended from said passive key button towards one side of said first circuit board, each of both guide studs is wound respectively with a compressed spring, both guide studs are able to be fitted into the containment holes of said first circuit board so as to serve as a guide and to cause said passive key button to make a minor incremental displacement thereby being able to tap said microswitch for said passive key button.

6. The mouse of claim 4, wherein an elastic action rod is provided for said first circuit board with its one end fixed to said first circuit board, and the other end fixed to the unstressed end the axle of said scroll wheel, with the aid of said elastic actuation rod, said axle is able to restore its initial state when the force is released from said scroll wheel.
